(19) United States
(12) Patent Application Publication
(10) Pub. No.: US 2026/0055820 A1
(43) Pub. Date: Feb. 26, 2026

(54) Remote Motorized Cryogenic Valve Controller

(71) Applicant: Brookhaven Science Associates, LLC, Upton, NY (US)

(72) Inventors: Edwin G. Haas, Port Jefferson Station, NY (US); AM Milinda Abeykoon, East Setauket, NY (US); John G. Trunk, North Babylon, NY (US)

(21) Appl. No.: 19/308,104

(22) Filed: Aug. 22, 2025

Related U.S. Application Data
(60) Provisional application No. 63/686,439, filed on Aug. 23, 2024.

(51) Int. Cl. F16K 31/04; F16H 1/18; F16K 31/53

(52) U.S. Cl. CPC F16K 31/043; F16H 1/18; F16K 31/042; F16K 31/535

(57) ABSTRACT

A kit for retrofitting a manual cryogenic fluid transfer line generally includes a hub unit configured for attachment to a manual control knob of the manual cryogenic fluid transfer line and a motor unit kinematically coupled to the hub unit for rotating the hub unit whereby the manual control knob rotates. A method for retrofitting a manual cryogenic fluid transfer generally includes attaching a hub unit to a manual control knob of the manual cryogenic fluid transfer line and coupling a motor unit to the hub unit for rotating the hub unit. A motor-controlled cryogenic fluid transfer line generally includes a cryogenic fluid transfer line, a hub unit attached to the cryogenic fluid transfer line for controlling flow of cryogenic fluid through the transfer line and a motor unit kinematically coupled to the hub unit for rotating the hub unit to adjust flow of cryogenic fluid through the line.

### CROSS-REFERENCE TO RELATED APPLICATIONS

This application is a Non-Provisional application which claims benefit of U.S. Patent Provisional Application No. 63/686,439, filed on Aug. 23, 2024, which is herein incorporated by reference in its entirety.

### STATEMENT OF GOVERNMENT RIGHTS

The present application was made with government support under contract number DE-SC0012704 awarded by the United States Department of Energy. The United States government has certain rights in the invention(s).

### BACKGROUND

The present invention relates generally to a valve controller and more particularly to a remote motorized cryogenic valve controller and a kit and method for retrofitting an existing cryogenic fluid transfer line.

Many research facilities utilize cryogenic fluid transfer lines that supply cryogens from dewars to equipment used for performing experiments. These cryogenic transfer lines have flow control valves that must be adjusted manually. For example, a knurled brass knob is typically provided in a transfer line to adjust the flow of liquid helium (LHe). Staff members must be on-site to adjust the helium flow manually to maintain specific temperatures. Many flow adjustments must be made during cool-down and operation. This is especially important during temperature transitions and when heat loads change.

Large dewars (e.g., 100-liter capacity) containing cryogenic fluids are often used in rooms or enclosures with limited size and ventilation. Manual adjustments of flow can be frequent depending on the experiments conducted. Such manual cryogenic fluid flow adjustments require personnel to be in the same room or enclosure as the vessels containing the cryogenic fluids. Since at least one person is needed to manually make flow adjustments, this person must be in close proximity to a source of cryogenic liquid. If a leak occurs and with inadequate ventilation, there is a risk for asphyxiation from oxygen deficiency as oxygen is displaced by an expanding cryogenic fluid.

Only manually controlled, portable, light-weight cryogenic transfer lines are available commercially to transfer cryogens from cryogenic dewars to devices that need accurate temperature control. Although custom, fixed cryogenic lines are designed for specific installations, no kits are known to be available to retrofit existing portable transfer lines from manual to remote control.

Moreover, when operating unattended for extended time periods at minimum temperature, the cryogenic transfer line manually operated flow valve is generally operated ‘wide open.’ Although this assures the lowest temperature is maintained, excessive cryogens are consumed. Considering the high cost of cryogens such as liquid helium, the investment cost of a remotely controlled motorized cryogenic valve controller would be recouped very quickly in lower cryogen use.

Thus, the ability to control flow remotely is needed. The need to make flow adjustments remotely for cryogenic fluids has increased lately due to an increased desire to control experiments and processes remotely. Remote control of cryogen flow will simultaneously improve temperature control, safety and cost, and will allow programmed flow adjustment to improve temperature control. In this regard, there is also a desire to retrofit existing manual transfer lines with this capability.

### SUMMARY

According to one aspect of the present invention, a kit for retrofitting a manual cryogenic fluid transfer line is provided. The kit generally includes a hub unit configured to be attached to a manual control knob of the manual cryogenic fluid transfer line and a motor unit kinematically coupled to the hub unit for rotating the hub unit whereby the manual control knob of the manual cryogenic fluid transfer line rotates.

In one embodiment, an outer radial surface of the hub unit is provided with an arrangement of gear teeth and the motor unit comprises a pinion with grooves engaged with the gear teeth of the hub unit.

In another embodiment, the hub unit includes a hub and a gear. The hub has an inner radial surface and an outer radial surface, wherein the inner radial surface is configured to receive the manual control knob of the manual cryogenic fluid transfer line. The gear has an inner radial surface and an outer radial surface, wherein the inner radial surface is configured to receive the hub and the outer radial surface is configured to engage the motor unit. The outer surface of the gear is also preferably provided with an arrangement of gear teeth and the motor unit comprises a pinion with grooves engaged with the gear teeth of the gear. Also, the outer radial surface of the hub is preferably formed with at least one spline and the inner radial surface of the gear is formed with at least one groove for receiving the at least one spline of the hub.

In either case, the kit further includes at least one set screw for attaching the hub unit to the manual control knob of the manual cryogenic fluid transfer line. The motor unit is preferably remote controlled, and the kit further preferably includes a housing surrounding the hub unit and the motor unit, wherein the housing is configured to be clamped to the manual cryogenic fluid transfer line.

In another aspect of the present invention, a method for retrofitting a manual cryogenic fluid transfer line is provided. The method includes attaching a hub unit to a manual control knob of the manual cryogenic fluid transfer line and coupling a motor unit to the hub unit for rotating the hub unit, whereby rotation of the hub unit rotates the manual control knob of the manual cryogenic fluid transfer line.

The step of attaching the hub unit may include attaching a hub of the hub unit to the manual control knob and attaching a gear to the hub. The method may also include clamping a housing around the hub unit and the motor unit.

In still another aspect of the present invention, a motor-controlled cryogenic fluid transfer line is provided. The motor-controlled cryogenic fluid transfer line generally includes a cryogenic fluid transfer line, a hub unit attached to the cryogenic fluid transfer line for controlling a flow of cryogenic fluid through the cryogenic fluid transfer line and a motor unit kinematically coupled to the hub unit for rotating the hub unit to adjust the flow of cryogenic fluid through the cryogenic fluid transfer line.

As described above, in one embodiment, an outer radial surface of the hub unit is provided with an arrangement of gear teeth and the motor unit comprises a pinion with grooves engaged with the gear teeth of the hub unit.

In another embodiment, the hub unit includes a hub having an outer radial surface and a gear having an inner radial surface and an outer radial surface, wherein the inner radial surface of the gear is configured to receive the hub and the outer radial surface of the gear is configured to engage the motor unit. In this embodiment, the outer surface of the gear is provided with an arrangement of gear teeth and the motor unit comprises a pinion with grooves engaged with the gear teeth of the gear. Also, the outer radial surface of the hub is preferably formed with at least one spline and the inner radial surface of the gear is preferably formed with at least one groove for receiving the at least one spline of the hub.

In this aspect, the motor unit is also preferably remote controlled, and a housing is preferably provided for surrounding the hub unit and the motor unit, wherein the housing is also configured to be clamped to the cryogenic fluid transfer line.

As a result of the present invention, a lightweight, portable kit and method for retrofitting existing manual transfer lines (or be added to new transfer lines) is provided. The kit includes a lightweight, easy-to-use motor and controller (e.g., via Power-over-internet, Wi-Fi, or other control means).

### BRIEF DESCRIPTION OF THE DRAWINGS

The following drawings are presented by way of example only and without limitation, wherein like reference numerals (when used) indicate corresponding elements throughout the several views, and wherein:

FIG. 1. is a schematic drawing of a typical cryogenic transfer line of the prior art;

FIG. 2 shows an embodiment of the remote motorized cryogenic valve controller according to the present invention;

FIG. 3 is a cut-away view of the remote motorized cryogenic valve controller shown in FIG. 2;

FIG. 4 is an exploded perspective view of the remote motorized cryogenic valve controller shown in FIGS. 2 and 3;

FIG. 5 is a cut-away perspective view of another embodiment of the remote motorized cryogenic valve controller according to the present invention;

FIG. 6 is a cross-sectional view of the remote motorized cryogenic valve controller shown in FIG. 5; and

FIG. 7 is an isolated perspective view of the hub, gear and set screws of the remote motorized cryogenic valve controller shown in FIGS. 5 and 6.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

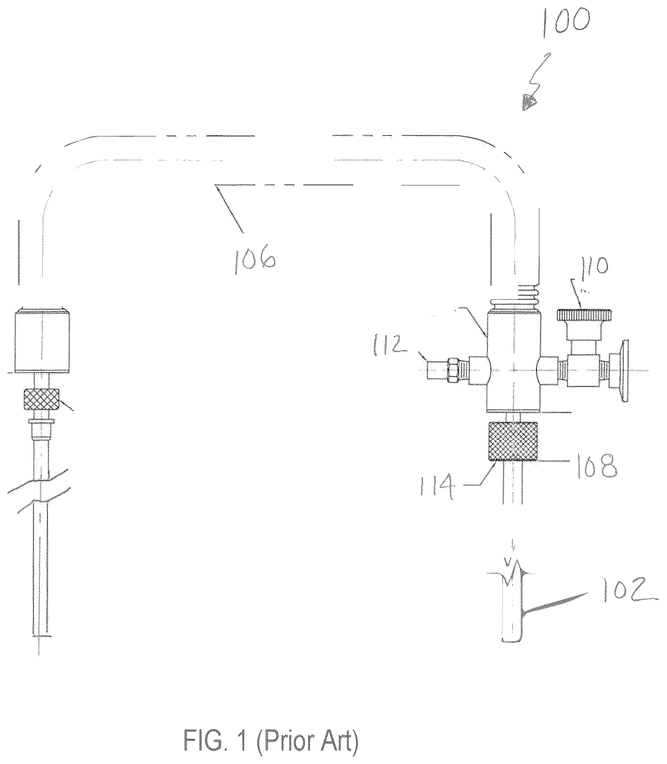

FIG. 1. is a schematic drawing of a typical cryogenic transfer line 100 of the prior art. The transfer line 100 shown in FIG. 1 is used to transfer cryogenic fluids from a storage vessel or dewars (not shown) to laboratory equipment (not shown) for performing experiments. However, the present invention is not limited to cryogenic transfer lines and can be utilized in any fluid transfer lines in a laboratory or commercial environment where a transfer line is used manually to control the flow of a cryogenic fluid.

The transfer line 100 generally includes a storage vessel insert portion 102 which is inserted in the vessel holding the fluid to be transferred. Opposite the storage vessel insert portion 102 is the workstation delivery portion 104, which delivers the fluid to a laboratory workstation for performing experiments. A flex hose 106 connects the storage vessel insert portion 102 to the workstation portion 104. A manual control valve 108 for controlling the fluid transferred along the line is typically located on the storage vessel insert end 102. The transfer line 100 may also include an evacuation valve 110 and a safety pressure relief valve 112.

The workstation portion 104 generally has a hollow tube to facilitate flow of cryogenic fluid with an opening at the extreme lower end to facilitate entrance of cryogenic fluid which is regulated by the long concentric valve stem that interfaces with the tube opening at the lower end of the workstation portion. The valve stem and concentric tube are generally fabricated from a stainless-steel alloy with minimal material cross section and poor heat transfer properties.

The control valve 108 typically includes a cylindrical knob 114 rotatably connected to the storage vessel insert portion 102. Rotation of the knob 114 opens or restricts flow of fluid through the storage vessel insert portion 102 as needed for a particular experiment. The knob 114 typically has a knurled outer surface to facilitate manual gripping of the knob.

The present invention is a retrofit kit for existing cryogenic transfer lines 100 as shown in FIG. 1. It works by clamping a motorized valve housing with a remote controller onto the cryogenic flow control valve. After installation and adjustments are completed, this invention then provides remote control of the cryogenic flow control valve.

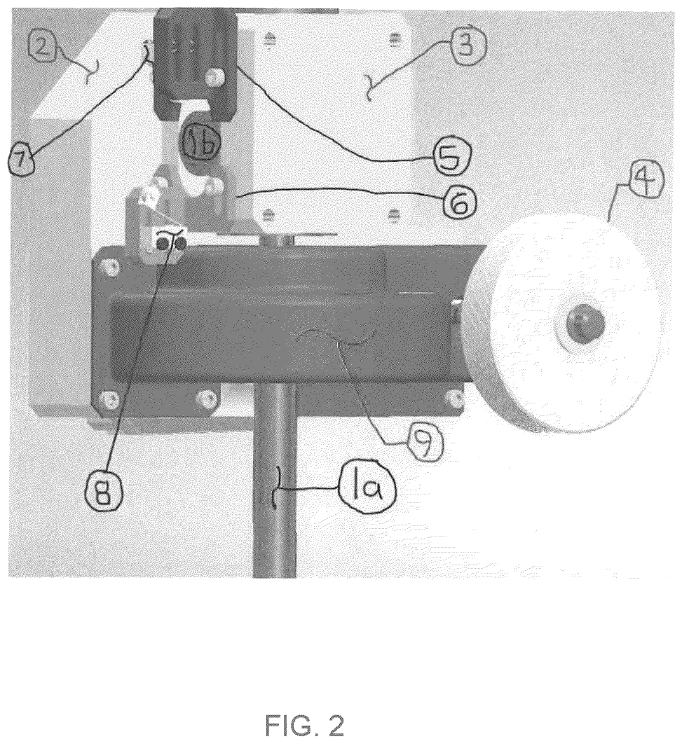

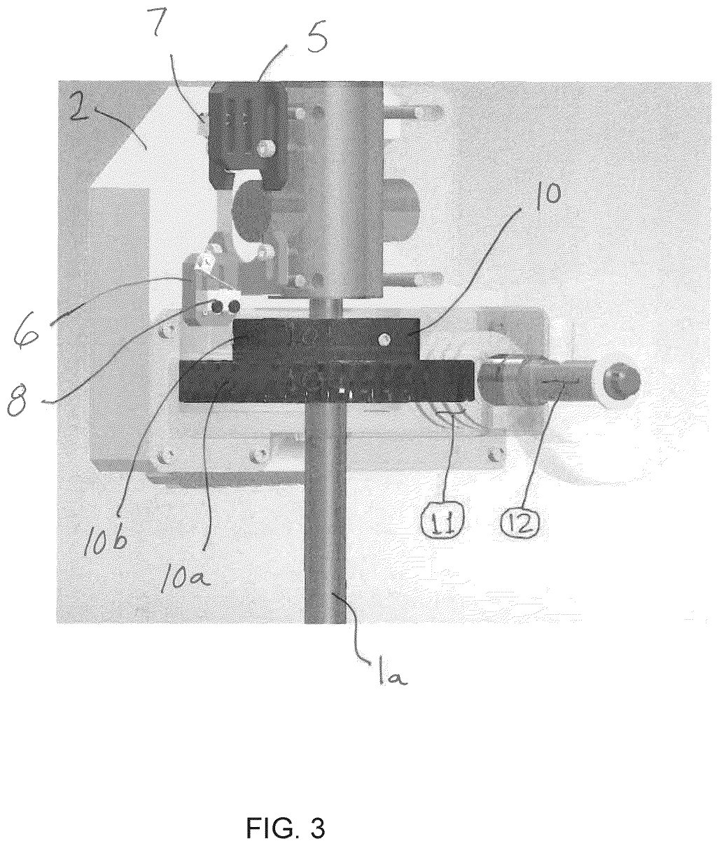

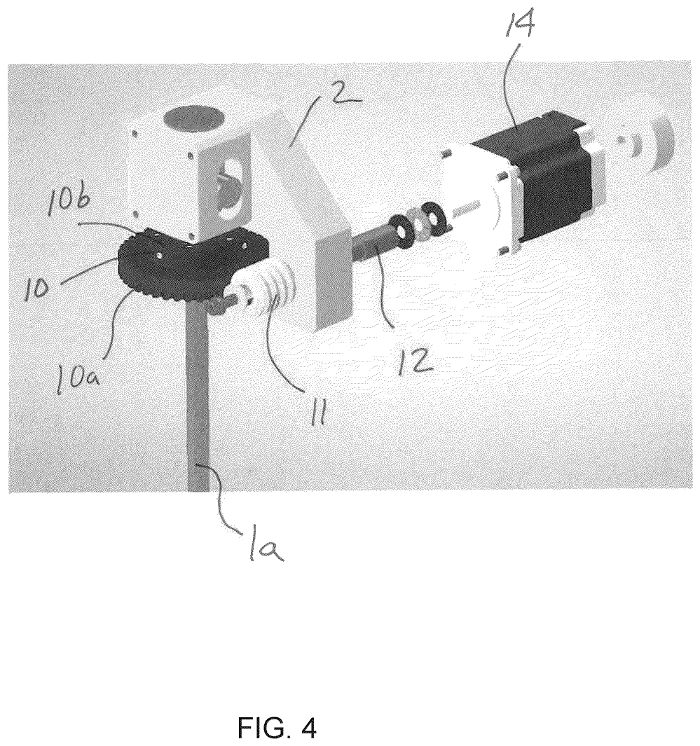

Specifically, as shown in a first embodiment of the present invention in FIGS. 2-4, a hub unit 10 is attached to the knob 114 of the existing fluid transfer line 100. In the embodiment shown in FIGS. 3 and 4, the hub unit 10 has a hub 10b and a separate gear 10a fixed to the hub 10b. However, it is conceivable for the gear 10a and the hub 10b to be a single integrally formed part to form a hub unit 10.

In any case, the hub unit 10 can be attached to the knob 114 in any manner so long as the hub unit does not rotate with respect to the knob. For example, the hub 10b can have an inner diameter sized to be form-fit or press-fit around the outer circumferential diameter of the knob 114. The hub 10b can take the form of a split-ring that is clamped to the knob using one or more suitable fasteners. The hub 10b can also be attached directly to the knob using fasteners that penetrate into or otherwise engage the knob. Again, what is important is that the hub 10b is securely fixed to the knob in a manner in which rotation of the hub 10b imparts a reciprocal precise rotation of the knob 114.

A gear 10a is fixed to the hub 10b in a similar fashion whereby the gear 10a is not permitted to rotate with respect to the hub 10b. As will be discussed in further detail below, the hub 10b can be splined, grooved, or have other means of allowing it to slide axially relative to the large gear 10a in a manner that allows the hub 10 to slide axially. This allows linear movement of the valve body (one part of item 1a) relative to the concentric internal valve stem (the other part of item 1a). However, other means of attachment are suitable.

The gear 10a is annular in shape and has an inner clearance for a portion 1a of the fluid transfer line and possibly for a portion of the knob 114 not engaged with the hub 10b. The gear 10a is also formed with gear teeth on its outer circumferential perimeter for engagement with a pinion 11 provided on an axle 12 extending from a motor 14. The axle 12 extends from the motor 14 in a direction perpendicular to the axis of rotation of the knob 114, hub 10b and gear 10a.

The pinion 11 is formed with a helical groove on its outer surface, which meshes with the teeth formed on the gear 10a. Rotation of the pinion 11 by the motor 14 causes the gear 10a to rotate due to the intermeshing of the gear teeth of the gear 10a with the helical coil of the pinion.

An inner housing block 2 and an outer housing block 3 are clamped together to form a housing around the portion 1a of the fluid transfer line 100 adjacent to the flow control valve 108. A pinion cover guard 9 is also preferably provided to cover the gear 10a and the hub 10b. The inner housing block 2 and the outer housing block 3 can be fastened together with screws or other fasteners. Similarly, the pinion cover guard 9 can be fastened to the housing formed by the inner housing block 2 and the outer housing block 3 using suitable fasteners. All fasteners should be properly torqued to ensure the housing blocks and guard are secure but not damaged.

The motor axle 12 preferably protrudes out of the pinion gear cover guard 9 so that a manual adjusting (control) knob 4 can be attached to an accessible end of the axle. The knob 4 is provided to enable manual operation of the control valve 108 if necessary.

Limit switches may be provided to set full-open and full-closed valve limits. For example, an upper limit switch 7 can be mounted on an upper hard stop bracket 5, which, in turn, is mounted to one of the inner housing block 2 or the outer housing block 3 to set maximum closure of cryogenic flow valve. Similarly, a low limit switch 8 can be mounted to a lower hard stop bracket 6, which is also mounted to one of the inner housing block 2 or the outer housing block 3 to set maximum opening of cryogenic flow valve. After the position of these hard stops are set (with the respective fasteners properly torqued), limit switch positions are set by sliding the limit switches to the full-open and full-closed positions and the switch fasteners are torqued where the switch contacts just change state. After connecting the wiring connectors for the motor 14 and switches to a control system, the maximum motor torque may be set within motor-control software (this is an optional step to be performed if a concern for damaging the flow control valve through excessive torque exists).

Alternatively, the housing may be designed to limit valve adjuster travel. Using standard M-Drive motors (e.g., NEMA 17 or NEMA 23 motors), calculations have shown that the housing components may be designed to limit valve travel without using switches. For large motors where excessive torque can cause component damage, the maximum motor torque may be limited, for example, by setting maximum motor current within the control system as per maximum torque recommendations from the cryogenic flow control valve manufacturer.

A compact control unit (not shown), located remotely or locally, sends electrical power/pulses to the motor. The motor 14 rotates the axle 12, which rotates the pinon 11. The pinion 11, which can also be termed a worm gear, mates to the pinion gear 10a, which is attached to the hub 10b. This hub 10b turns the knob 114 of the cryogenic flow control valve 108 and can translate (within limits set by either the housing design or the limit switches). Either a servomotor, stepper motor, or other type of motor may be used to turn the cryogenic flow control valve. Additionally, one or more encoders may be used to provide valve position feedback to the controller.

In this embodiment, the inner housing block 2 and the outer housing block 3 are made from aluminum and the guard 9 is made from plastic to prevent contact with the internal gears. However, other materials may be used as long as they are adequate and cost effective for each item.

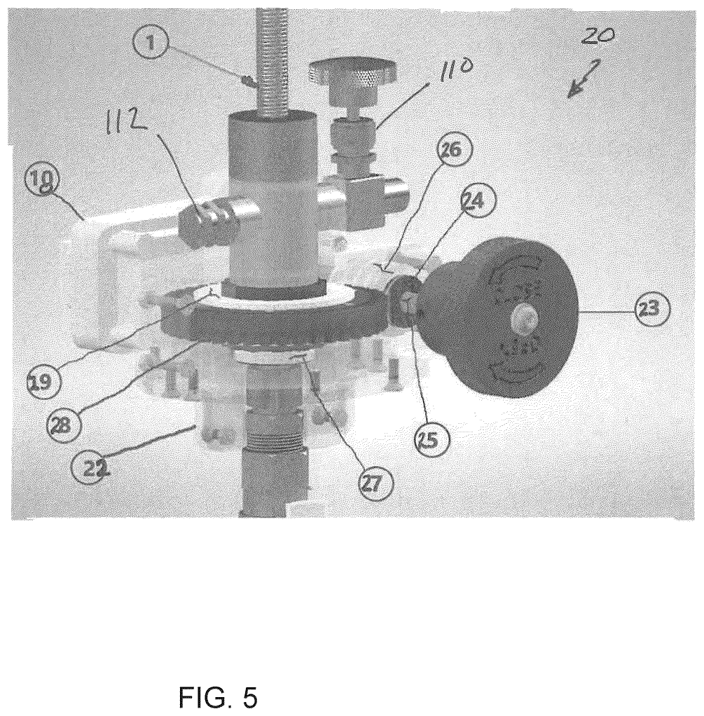

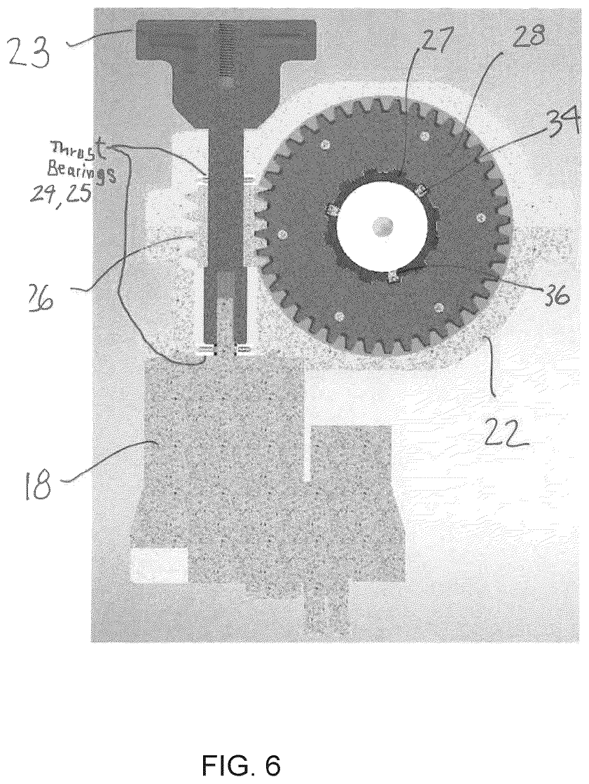

FIGS. 5 and 6 show an alternative embodiment of a kit 20 of the present invention using lighter components and a smaller NEMA 17 motor 18 resulting in a device that is significantly less expensive to produce than the first embodiment. This embodiment includes 3D-printed plastic parts in place of metal parts, and the housing 22 is redesigned with more internal thrust bearings 24 to assure long, smooth trouble-free operation. A built-in hex pattern on the new housing 22 facilitates fast attachment to cryogenic dewars and prevents torque-induced rotation.

In this embodiment, the housing 22 can be made from clear plastic so movement of the internal gears is visible. Also, the manual knob 23 of device 20 has markings to show users which way it may be turned to increase or decrease flow when making manual adjustments.

The device 20 of this embodiment is attached to an existing cryogenic transfer line 1 in a similar manner as that described above. In particular, a hub 27 is first attached to the manual control valve knob 114 of the existing line 1. A gear 28 is then attached to the hub 27 and the housing 22 is assembled around the hub and gear.

In this case, the housing 22 is made in four parts and is designed to take advantage of the T-configuration of the typical evacuation valve 110 and safety pressure relief valve 112 located just above the control valve 108. Specifically, two of the housing parts are clamped together around the T-configuration and fastened together using conventional fasteners. A lower gear portion of the housing and an upper gear portion of the housing are then assembled around the hub 27 and the gear 28. The gear portions are then fastened to the two housing parts clamped around the T-configuration. As a result, the housing 22 is fixed to the cryogenic line in a non-displaceable manner.

As mentioned above, the kit 20 of this embodiment includes a thrust bearing/thrust washer arrangement, wherein one bearing 25 is surrounded by two washers 24 on each side of the worm gear 26. Additionally, a ring gear thrust arrangement 29 is also preferably provided in which a thrust bearing is surrounded by two thrust washers on each side of the ring gear 28.

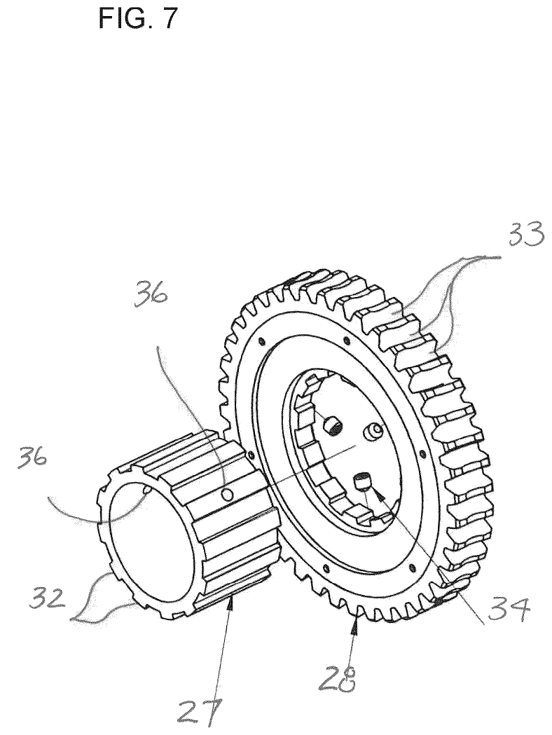

As shown additionally in FIG. 7, the hub 27 in this embodiment is formed with at least one spline 32 on its outer radial surface that fits within a groove 33 formed on an inner radial surface of the gear 28. As shown in the drawings, (e.g., FIG. 7) the hub 27 is provided with a series of splines 32 spaced apart along the entire outer periphery of the hub. These splines 32 nest within a series of grooves 33 formed in the gear 28. In this manner, a strong non-rotatable fit is ensured between the hub 27 and the gear.

As also shown particularly in FIGS. 6 and 7, set screws 34 are used to secure the hub 27 to the existing control valve knob 114. One or more threaded holes 36 are formed through the wall of the hub for receiving the set screws 34. Once the hub 27 is in position around the existing control knob 114, the set screws 34 can be screwed into the holes 36 of the hub from the outer radial side of the hub and driven to engage the knob. The set screws 34 have a height that is less than the thickness of the radial wall of the hub so as not to protrude beyond the outer radial surface of the hub and interfere with the fitting of the gear 28.

Once attached to the knob 114 of the existing cryogenic line, the splined hub 27 is nested within the splined gear 28. The ring gear thrust arrangement 29 can then be attached using fasteners and threaded holes provided on the gear. The housing parts are then assembled together and the motor 18 and knob 23 can be attached to complete the assembly.

Manual cryogenic fluid transfer lines are readily available at reasonable cost. Therefore, the present invention can cost-effectively retrofit existing lines with remote flow controls, or cryogenic transfer line manufacturers can offer this invention as an option that customers can add to their existing transfer line order. This is a lightweight, fast retrofit kit that changes cryogenic fluid transfer lines from manual to remote cryogenic fluid flow control operation. The remote-control aspect of this invention will reduce the need for continuous support and improve safety if a cryogenic fluid leak occurs. Thus, this invention provides added benefits for temperature control and safety.

A valve controller in accordance with aspects of the present disclosure can be employed in essentially any cryogenic fluid transfer system. Systems incorporating such controller are considered part of this invention. Given the teachings of the present disclosure provided herein, one of ordinary skill in the art will be able to contemplate other implementations and applications of embodiments of the invention.

The illustrations of embodiments of the invention described herein are intended to provide a general understanding of the various embodiments, and they are not intended to serve as a complete description of all the elements and features of apparatus and systems that might make use of the remotely controlled motorized cryogenic valve controller and techniques described herein. Many other embodiments will become apparent to those skilled in the art given the teachings herein; other embodiments are utilized and derived therefrom, such that structural and logical substitutions and changes can be made without departing from the scope of this disclosure. The drawings are also merely representational and are not drawn to scale. Accordingly, the specification and drawings are to be regarded in an illustrative rather than a restrictive sense.

Embodiments of the invention are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose can be substituted for the specific embodiment(s) shown; that is, this disclosure is intended to cover any and all adaptations or variations of various embodiments. Combinations of the above embodiments, and other embodiments not specifically described herein, will become apparent to those of skill in the art given the teachings herein.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Terms such as “above” and “below” are used to indicate relative positioning of elements or structures to each other as opposed to relative elevation.

The corresponding structures, materials, acts, and equivalents of all means or step-plus-function elements in the claims below are intended to include any structure, material, or act for performing the function in combination with other claimed elements as specifically claimed. The description of the various embodiments has been presented for purposes of illustration and description but is not intended to be exhaustive or limited to the forms disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the various embodiments with various modifications as are suited to the particular use contemplated.

Given the teachings of embodiments of the invention provided herein, one of ordinary skill in the art will be able to contemplate other implementations and applications of the techniques of embodiments of the invention. Although illustrative embodiments of the invention have been described herein with reference to the accompanying drawings, it is to be understood that embodiments of the invention are not limited to those precise embodiments, and that various other changes and modifications are made therein by one skilled in the art without departing from the scope of the appended claims.

What is claimed is:

1. A kit for retrofitting a manual cryogenic fluid transfer line, the kit comprising:
a hub unit configured to be attached to a manual control knob of the manual cryogenic fluid transfer line; and
a motor unit kinematically coupled to the hub unit for rotating the hub unit whereby the manual control knob of the manual cryogenic fluid transfer line rotates.

2. The kit as defined in claim 1, wherein an outer radial surface of the hub unit is provided with an arrangement of gear teeth and the motor unit comprises a pinion with grooves engaged with the gear teeth of the hub unit.

3. The kit as defined in claim 1, wherein the hub unit comprises:
a hub having an inner radial surface and an outer radial surface, the inner radial surface configured to receive the manual control knob of the manual cryogenic fluid transfer line; and
a gear having an inner radial surface and an outer radial surface, the inner radial surface being configured to receive the hub and the outer radial surface being configured to engage the motor unit.

4. The kit as defined in claim 3, wherein the outer surface of the gear is provided with an arrangement of gear teeth and the motor unit comprises a pinion with grooves engaged with the gear teeth of the gear.

5. The kit as defined in claim 3, wherein the outer radial surface of the hub is formed with at least one spline and the inner radial surface of the gear is formed with at least one groove for receiving the at least one spline of the hub.

6. The kit as defined in claim 1, further comprising at least one set screw for attaching the hub unit to the manual control knob of the manual cryogenic fluid transfer line.

7. The kit as defined in claim 1, wherein the motor unit is remote controlled.

8. The kit as defined in claim 1, further comprising a housing surrounding the hub unit and the motor unit, the housing being configured to be clamped to the manual cryogenic fluid transfer line.

9. A method for retrofitting a manual cryogenic fluid transfer line, the method comprising:
attaching a hub unit to a manual control knob of the manual cryogenic fluid transfer line; and
coupling a motor unit to the hub unit for rotating the hub unit, whereby rotation of the hub unit rotates the manual control knob of the manual cryogenic fluid transfer line.

10. The method as defined in claim 9, wherein attaching the hub unit comprises:
attaching a hub of the hub unit to the manual control knob; and
attaching a gear to the hub.

11. The method as defined in claim 9, further comprising clamping a housing around the hub unit and the motor unit.

12. The method as defined in claim 9, wherein the motor unit is remote controlled.

13. A motor-controlled cryogenic fluid transfer line comprising:
a cryogenic fluid transfer line;
a hub unit attached to the cryogenic fluid transfer line for controlling a flow of cryogenic fluid through the cryogenic fluid transfer line; and
a motor unit kinematically coupled to the hub unit for rotating the hub unit to adjust the flow of cryogenic fluid through the cryogenic fluid transfer line.

14. The motor-controlled cryogenic fluid transfer line as defined in claim 13, wherein an outer radial surface of the hub unit is provided with an arrangement of gear teeth and the motor unit comprises a pinion with grooves engaged with the gear teeth of the hub unit.

15. The motor-controlled cryogenic fluid transfer line as defined in claim 13, wherein the hub unit comprises:
a hub having an outer radial surface; and
a gear having an inner radial surface and an outer radial surface, the inner radial surface being configured to receive the hub and the outer radial surface being configured to engage the motor unit.

16. The motor-controlled cryogenic fluid transfer line as defined in claim 15, wherein the outer surface of the gear is provided with an arrangement of gear teeth and the motor unit comprises a pinion with grooves engaged with the gear teeth of the gear.

17. The motor-controlled cryogenic fluid transfer line as defined in claim 15, wherein the outer radial surface of the hub is formed with at least one spline and the inner radial surface of the gear is formed with at least one groove for receiving the at least one spline of the hub.

18. The motor-controlled cryogenic fluid transfer line as defined in claim 13, wherein the motor unit is remote controlled.

19. The motor-controlled cryogenic fluid transfer line as defined in claim 13, further comprising a housing surrounding the hub unit and the motor unit, the housing being configured to be clamped to the cryogenic fluid transfer line.
